(19) United States
(12) Patent Application Publication
(10) Pub. No.: US 2014/0245386 A1
(43) Pub. Date: Aug. 28, 2014

(54) SYSTEM AND METHOD FOR ACCESS CONTROL MANAGEMENT

(71) Applicant: Barak ROSENBERG, Rehovot (IL)

(72) Inventor: Barak ROSENBERG, Rehovot (IL)

(21) Appl. No.: 13/938,258

(22) Filed: Jul. 10, 2013

Related U.S. Application Data
(60) Provisional application No. 61/669,687, filed on Jul. 10, 2012.

(51) Int. Cl. H04L 29/06

(52) U.S. Cl. CPC H04L 63/10
USPC 726/3

(57) ABSTRACT

A system or method of monitoring data accessed in operations or systems calls or functions to find in such data words, phrases or data strings that are to be transferred or subject to the system call. The data strings may be added to files as an indication that the file data is protected, or may be searched for as an indication of a suspicious data string. Data strings that are detected in the system call may serve as a trigger or indication that the data is to be subject to some review or screening process.

### CROSS REFERENCE TO RELATED APPLICATIONS

This application claims the benefit of U.S. Provisional Patent Application Ser. No. 61/669,687, filed on Jul. 10, 2012 and entitled “SYSTEM AND METHOD FOR ACCESS CONTROL MANAGEMENT”, which is incorporated in their entirety herein by reference.

### BRIEF DESCRIPTION OF THE DRAWINGS

FIG. 1 is a flow diagram of a method in accordance with an embodiment of the invention.

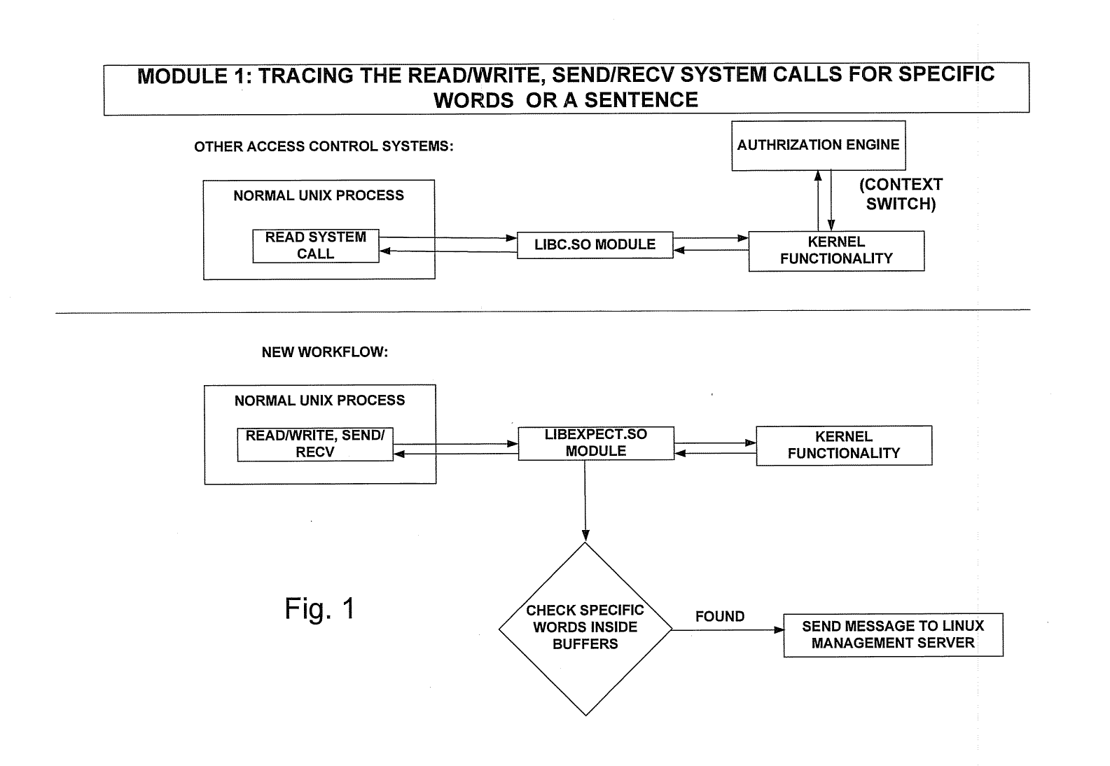

FIG. 2 is a conceptual diagram of a system in accordance with an embodiment of the invention.

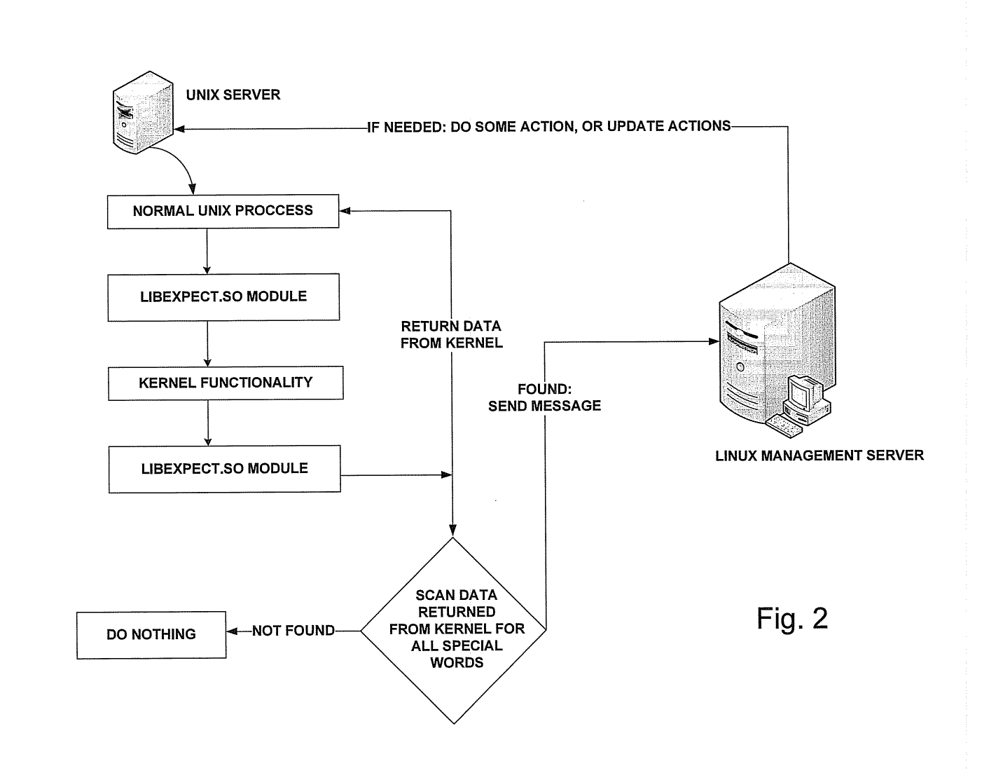

### EMBODIMENTS OF THE INVENTION

Described is an embodiment of a method and system for managing access control on UNIX based operating systems such as Linux, Solaris, Aix, Hp-Ux, and Android platforms. In some embodiments, a system may include one or more processors, memories, input/output devices, communication systems and displays. In some embodiments, a method may be performed by execution of instructions by a processor, such as instructions stored on a memory.

Specific operations/system calls that occur during operation of Unix based operating systems may be caught, trapped and analyzed for special words, phrases or data strings. Indications of such strings may be sent to a Linux management server that runs Internet Information Services. Indications may be shown on a web site that relates specific messages to specific Unix machines that may be registered through the main management server.

Data that is passed through the network between for example a main Linux management server and a UNIX machine, may use Simple Object Access Protocol (Soap) web services to communicate.

System calls may be caught inside Unix machines by using for example a LD _PRELOAD mechanism, which may add for example a special shared object module which may be loaded and used before or at the same time as libc.so module which is the interface that Unix user space applications use to access specific kernel functionality—see the attached Diagram for Module 1 which describes workflow of LD_PRELOAD.

A. Tracing the read/write, send/recv system to search for specific words, sentences or data strings.

To catch system calls, the system may use a shared library called “libexpect.so.1” that may be loaded by the user space program before the libc.so

To use libexpect.so, before libc.so module, a user with root privileges needs to add LD_PRELOAD variable to unix system, or add line to /etc/ld.so.preload.

By doing: #> export LD_PRELOAD=/lib/libexpect.so.1
or by doing: #> echo “/etc/libexpect.so.1” > /etc/ld.so.preload

An embodiment may use LD_PRELOAD to insert libexpect.so.1 module, to be used before the actual libc.so- if read function is defined there, then the read inside libexpect.so.1 will be used before the original read of libc.so.6 Instead of using a kernel module and replacing the sys_call_table functions, which are the real functions that the kernel uses to run system calls, a command called LD_PRELOAD is used, which adds libexpect.so shared module that replaces system call functions that are found before using the libc.so module. The LD_PRELOAD module is used before the libc.so module, meaning if the system has a function called read, inside the normal execution of a user space application, read is first searched inside libexpect.so. If it is found there, read is used from the code written inside libexpect.so. If read function does not exist there, then the original read from libc.so module is used to execute the normal read functionality inside the kernel. Below is an example of read function inside libexpect.so.1:

```
ssize_t
read(int fd, void *buf, size_t count)
{
  static ssize_t (*real_read)(int, void *, size_t) = NULL;
    ssize_t rv = 0;
    if (real_read == NULL) {
    real_read =
      (ssize_t (*)(int, void *, size_t))dlsym(RTLD_NEXT, “read”);
  }
  if (real_read) {
    rv=real_read(fd, buf, count);
    if (!words_loaded) {
        load_words( );
        words_loaded = 1;
    }
    for(int i = 0; i < num_of_words; i++ ) {
      if (memmem(buf, count , (char *) &words[i], strlen(words[i]))) {
        warning(“read found %s !!!\n”,words[i]);
      }
    }
    return (rv);
  } else {
    return (−1);
  }
}
```

Other examples and uses are possible.

Speed of the function may be achieved by avoiding use of the Kernel. A method and system may evaluate the data in a memory using for example an MEMEM function, and finding a pattern in the data. Such pattern may appear in for example a code such as a particular code that may be inserted or included in the data. The mem may be scanned as the Kernel moves data. In some embodiments a detection of a code or pattern may be used as a trigger to stop a function such as a read, write, store, transfer of other functions that act upon data. By stopping the action of such functions on for example a data file, there may be prevented an access to, transfer of or theft of the data.

In this read function inside libexpect.so.1 we do:
define real_read which is the original read function to be used in kernel.
use dlsym(RTLD_NEXT, “read”), to get the pointer of the original read system call.
call the original real_read, to execute the original read system call in the kernel, and not disturb the system
check if special file /etc/expect_words.txt that is used for the search words was loaded, if not load all search words.
move on all searched words, and use function memmem, which searches for specific word or string also in binary buffer to find the specific word, if found give a warning.
return original rv, return value from original read
if read function was not found in step 2, return −1.

The memmem functions locates a specific substring in a binary buffer, in this way even binary files are searched for a specific substring.

In this manner, normal operation of applications like Oracle SQL, IBM WebSphere and others that run on the Unix system, works without disturbance, and the special shared object works as a “ghost” seeing all the information in real time, but without affecting the speed of the running system.

During the read/write, system calls a data buffer that is passed as a parameter to the system call, is tested for the occurrence of specific words/sentence. Same goes to send/recv that sends/receives data to/from a socket—to the network.

In the event that some word or string appears in the data buffer of read/write, send/recv system call, a warning may be sent to the Linux management server, warning of some behavior or string appearance.

For example: words like “terror”, or “money” may be defined in the “expected_words.txt” file, any occurrence of these words, will raise a warning event to the management server. Data strings may be detected in image, data, audio or video files.

During normal execution of system calls including read/write, send/recv ALL buffers are searched for the occurrence of the “special” words, and this is done in real time without affecting the speed of UNIX machine.

I claim:

1. A system in accordance with the specification and drawings.

2. A method in accordance with the specification and drawings.
